(19) United States
(12) Patent Application Publication
(10) Pub. No.: US 2007/0244725 A1
(43) Pub. Date: Oct. 18, 2007

(54) SECURE INTERNET BASED SYSTEM FOR DATA REDUNDANCY

(76) Inventors: Goutham Sukumar, Sammamish, WA (US); Mrinal Bhasker, Bothell, WA (US); Prem S. Urali, Redmond, WA (US)

Correspondence Address: AXIOS LAW GROUP. PLLC, 1525 FOURTH AVENUE, SUITE 800, SEATTLE, WA, 98101, US

(21) Appl. No.: 11/690,719

(22) Filed: Mar. 23, 2007

Related U.S. Application Data
(63) Continuation-in-part of application No. 11/681,736, filed on Mar. 2, 2007.
(63) Continuation-in-part of application No. 11/611,124, filed on Dec. 14, 2006.
(60) Provisional application No. 60/743,752, filed on Mar. 24, 2006.
(60) Provisional application No. 60/767,087, filed on Mar. 2, 2006.
(60) Provisional application No. 60/597,637, filed on Dec. 14, 2005.

(51) Int. Cl. G06F 19/00

(52) U.S. Cl. 705/3

(57) ABSTRACT

A virtualized service system and method are provided herein.

### RELATED APPLICATIONS

This application is a non-provisional claiming the benefit of U.S. Provisional Patent Application No. 60/743,752, entitled SECURE INTERNET BASED SYSTEM FOR DATA REDUNDANCY, with the named inventors Goutham Sukumar, Mrinal Bhasker and Prem S. Urali, filed on Mar. 23, 2006; a continuation-in-part of U.S. patent application Ser. No. 11/681,736 entitled VIRTUALIZING SERVICES SYSTEM AND METHOD, with the named inventors Goutham Sukumar, Mrinal Bhasker and Prem S. Urali, filed on Mar. 2, 2007, which is a non-provisional claiming the benefit of U.S. Provisional Patent Application No. 60/767,087 entitled VIRTUALIZING SERVICES SYSTEM AND METHOD, with the named inventors Goutham Sukumar, Mrinal Bhasker and Prem S. Urali, filed on Mar. 2, 2006; and a continuation-in-part of U.S. patent application Ser. No. 11/611,124 entitled SECURE COMMUNICATION SYSTEM AND METHOD, with the named inventors Prem S. Urali, John Azariah, Kumar Ranvijay, and Mrinal Bhasker, filed on Dec. 14, 2006, which is a non-provisional claiming the benefit of U.S. Provisional Patent Application No. 60/597,637, entitled SECURE COMMUNICATION SYSTEM AND METHOD, with the named inventors Prem S. Urali, John Azariah, Kumar Ranvijay, and Mrinal Bhasker, filed on Dec. 14, 2005; the entireties of which are hereby incorporated by reference.

### FIELD

The present invention generally relates to digital communications, and more specifically to digital communications for maintaining digital data.

### BACKGROUND

In a widely distributed network which connects different entities that share data between themselves, there is a need for a mechanism that enables each entity in the network to access data generated from other entities even when the source entities are not readily available or accessible.

Communications between electronic devices have also improved in recent years. Communication networks are well known in the computer communications field. By definition, a network is a group of computers and associated devices that are connected by communications facilities or links. Network communications can be of a permanent nature, such as via cables, or can be of a temporary nature, such as connections made through telephone or wireless links. Networks may vary in size, from a local area network (“LAN”), consisting of a few computers or workstations and related devices, to a wide area network (“WAN”), which interconnects computers and LANs that are geographically dispersed, to a remote access service, which interconnects remote computers via temporary communication links. An internetwork, in turn, is the joining of multiple computer networks, both similar and dissimilar, by means of gateways or routers that facilitate data transfer and conversion from various networks. A well-known abbreviation for the term Internetwork is “internet.” As currently understood, the capitalized term “Internet” refers to the collection of networks and routers that use the Internet Protocol (“IP”), along with higher-level protocols, such as the Transmission Control Protocol (“TCP”) or the Uniform Datagram Packet (“UDP”) protocol, to communicate with one another.

Networked appliances are generally a combination of hardware and software components that provide, among other functionality, communications between different organizations.

Data is a valuable asset to organizations. Organizations routinely use data contained in their computer systems for various purposes such as performing analyses, making decisions etc. Data may be exchanged between organizations to aid each other in conducting business. For example, in a clinical setting, organizations such as hospitals and clinician practices may exchange patient treatment data to help provide better care for patients and also to save costs and increase efficiency by eliminating duplicate work. However, there may be multiple points of failure which can cause an organization to lose data. These include, but are not limited to, failure of computer components such as motherboards, storage drives, tape subsystems etc, loss of entire data storage facilities to calamities such as earthquakes, floods, hurricanes etc.

There are several technologies that can assist organizations to protect their data and ensure that the data can be restored in the event of failures and calamities.

One such technology is backup software, which can backup data to removable media such as magnetic tapes, optical drives, removable Hard Disks etc. Organizations can perform regular backups of the data and move the media on which the backups are taken to secure locations away from the location where the computer systems are located. However, there are several issues to using backup software and procedures. They may be expensive and may require substantial amounts of planning and oversight. They may also require continuous oversight by expert personnel to ensure timely execution. Storing data at offsite locations may also require expensive arrangements with companies that specialize in such services. While this mechanism protects organizations from losing data, it does not address the situation of a network failure which prevents other organizations from retrieving relevant information from the source.

Another alternative mechanism for enabling data recovery may be to replicate all data at a separate remote location using various mechanisms that are tailor made for each type of application. This means the organization may have to select a remote data replication strategy that works for the specific type of software that is used. Additionally, such maintenance of remote redundancy mechanisms can be very expensive to setup and maintain. Such redundant storage of information still does not address the scenario that arises when the organizations that originate the data are inaccessible to the consuming organizations.

### BRIEF DESCRIPTION OF THE FIGURES

FIG. 1 is a system diagram of a number of devices in a network in accordance with one embodiment.

FIG. 2 is a block diagram of a network services interface device that provides an exemplary operating environment for one embodiment.

FIG. 3 is a block diagram of an appliance that provides an exemplary operating environment for one embodiment.

FIG. 4 is a diagram illustrating the actions taken by devices in a secure communications system to register an appliance in accordance with one embodiment.

FIG. 5 is a flow diagram illustrating a registration routine in accordance with one embodiment.

FIG. 6 is a diagram illustrating the actions taken by devices in a secure communications system for sending a secure message in accordance with one embodiment.

FIG. 7 is a flow diagram illustrating an introduced secure message routine in a sending appliance in accordance with one embodiment.

FIG. 8 is a flow diagram illustrating an introduced secure message routine on the network services interface in accordance with one embodiment.

FIG. 9 is a flow diagram illustrating an introduced secure message routine on a receiving appliance in accordance with one embodiment.

FIG. 10 is a diagram of the actions by devices in a secure communications system for sending a secure message between persons in accordance with one embodiment.

FIG. 11 is a flow diagram illustrating the person-to-person secure message processing on a receiving appliance in accordance with one embodiment.

FIG. 12 is a flow diagram illustrating service registration between network devices in accordance with one embodiment.

FIG. 13 is a diagram of the actions by devices in a virtual services system for performing a local service in accordance with one embodiment.

FIG. 14 is a diagram of the actions by devices in a virtual services system for performing a remote service in accordance with one embodiment.

FIG. 15 is a flow diagram illustrating a processing a service request in accordance with one embodiment.

FIG. 16 is a diagram of the actions by devices in a data storage system for registering a patient in accordance with one embodiment.

FIG. 17 is a diagram of the actions by devices in a data storage system for handling a document in accordance with one embodiment.

FIG. 18 is a flow diagram illustrating a document handling routine in accordance with one embodiment.

FIGS. 19-21 are diagrams of the actions by devices in a data storage system for looking up a document in accordance with various embodiments.

FIG. 22 is a flow diagram illustrating a document retrieval subroutine in accordance with one embodiment.

FIG. 23 is a flow diagram illustrating a document pre-fetch routine in accordance with one embodiment.

### DETAILED DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

Organizations may like to leverage the ubiquity of the internet and the breadth of connectivity it offers to propagate data between different divisions within the organization and also share data with external organizations to streamline the day to day operation of the business. For example, a particular law enforcement agency may wish to share information about criminals or suspects with other agencies in the same region to ensure swift and accurate decisions to be made when the criminal or suspect is encountered. As the same individual is encountered in various locations in the region, each agency may collect and maintain information about the person. As more and more information is collected about the individual, such information is propagated to other agencies in the same region. Besides making the information readily available to other agencies, this scheme also ensures that information about any one individual may be retrieved from multiple locations in the region, thus providing a higher level of redundancy than that is possible for a central or local storage infrastructure. An extension to the scheme also proposes a design whereby information is proactively propagated to those nodes in the network that anticipate the need for having such documents.

In the context of a healthcare information network, using the above scheme, clinical practices may exchange information about patients with other practices in the same region which also are known to have the same patient registered there. As information changes or is added to the patients records, it is also continuously propagated to other practices, thereby providing multiple locations in the region where the same patients information may reside. If the information systems at one of the practices were to fail or be otherwise unavailable, data about patients are still accessible from other practices in the network. In addition, any provider location that does not hold the patient records for a specific patient, but anticipates the need for such documents to be made available, can request a synchronization of such documents from locations from where they are available.

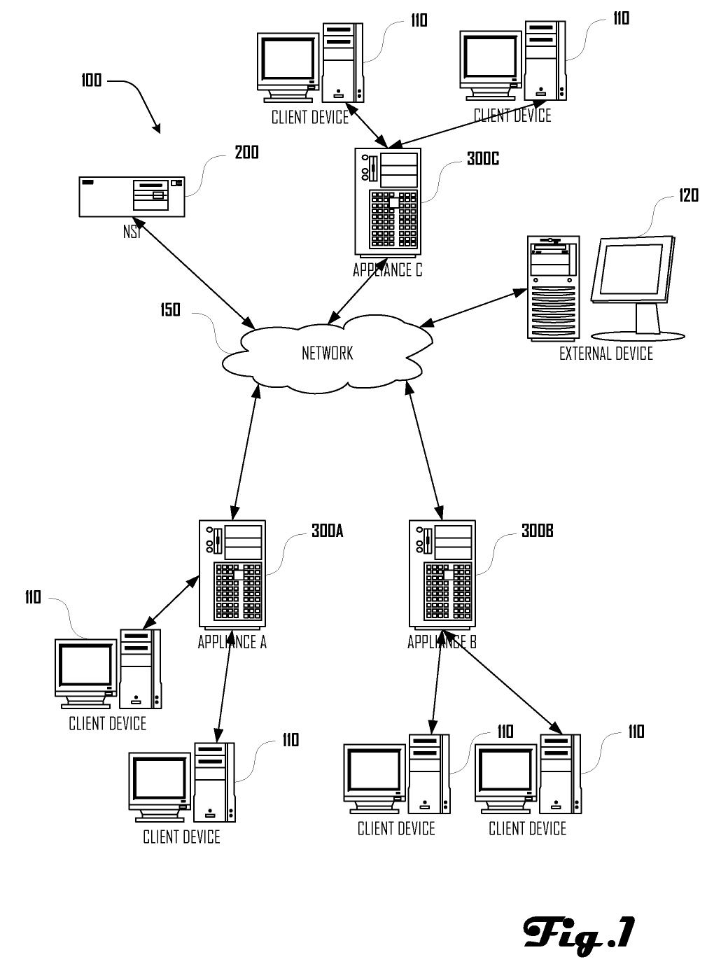

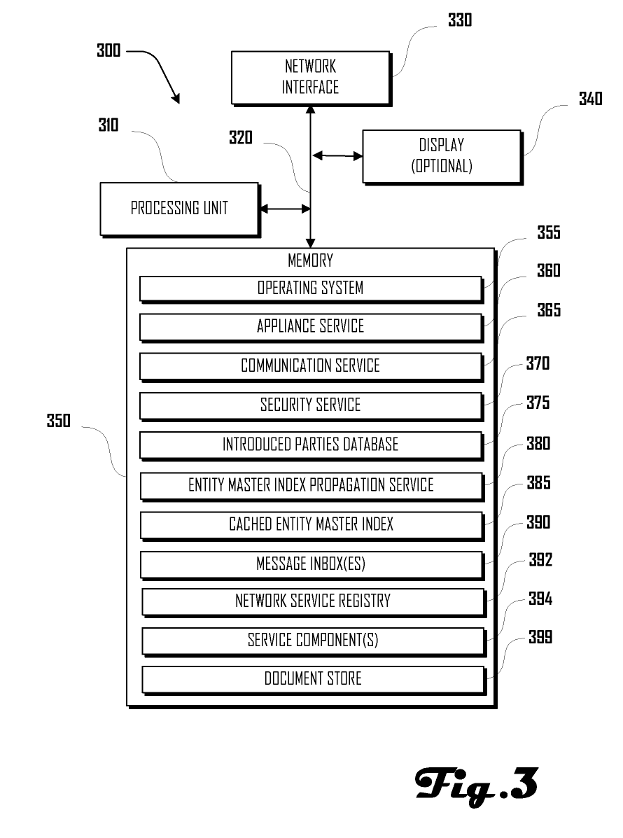

FIG. 1 illustrates a network where appliances 300 belonging to different organizations participate in communications with one another using peer-to-peer communications (or other forms of electronic communications). In FIG. 1, Organizations exchange information between one another. Each organization may have a corresponding Appliance 300A-C, or alternatively may be associated with an appliance that is shared between different organizations (not shown). An Appliance 300 (illustrated in FIG. 3 and described below) is a computer or device that contains the software services used by an organization to communicate with another organization. The client devices 110 may comprise computers and/or programs/applications which expose the services provided by the system 100 to the human users, or may also include programs that integrate data from other applications that reside within the organizations or outside them.

The secure communications system 100 (“system”) represents a set of technologies which enable each of the Appliances 300A-C to exchange messages with one another securely and privately on behalf of the organization that is represented by the appliance. The Network Services Infrastructure 200 (“NSI”) may include software services as well as hardware that enable the coordination of the communications between the different appliances 300A-C.

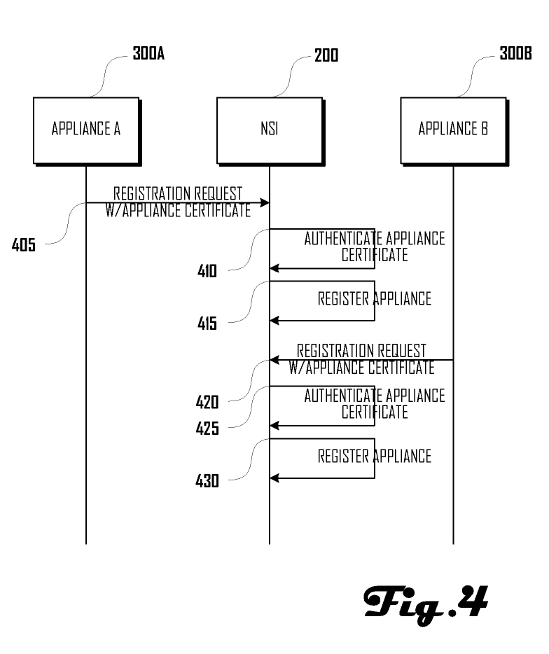

In one exemplary embodiment, any given pair of appliances 300A-C communicating with each other in a peer-to-peer fashion can mutually authenticate each other initially with the help of NSI 200 that introduces the appliances to each other. Once the mutual introduction is performed, the appliances can communicate with each other securely independent of the NSI 200 (see FIG. 4 and below).

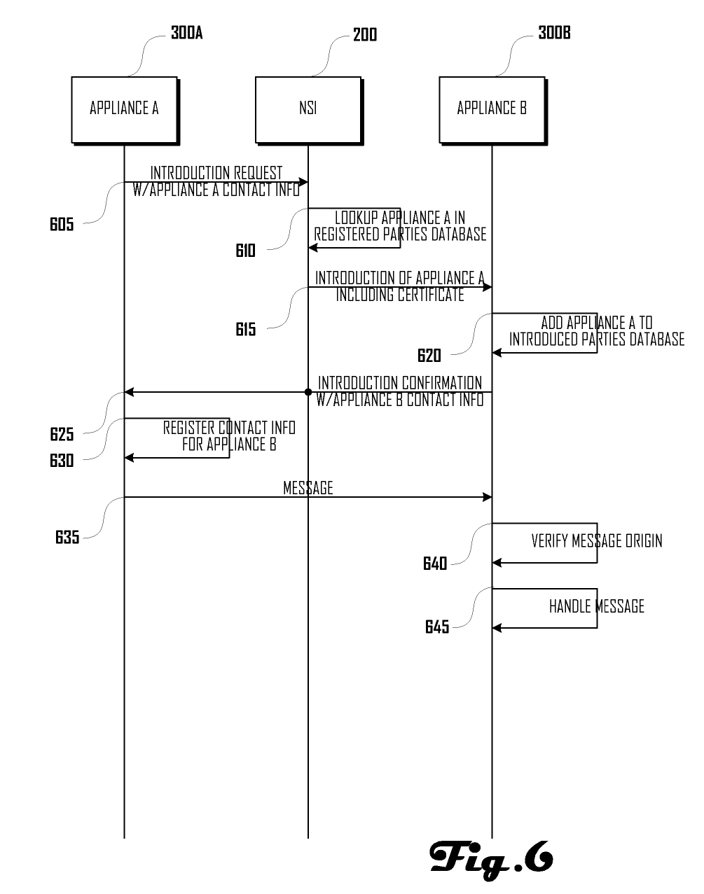

Once the introduction is performed, the communication can be two-way, with no restriction on which appliance has to initiate it (see FIG. 6 and below). The only times when the NSI 200 may be involved is when one of the appliances fails to establish communication with the other. For example, when one appliance fails/ceases to respond and the other appliance becomes unable to send a request to the failed appliance. Alternately, if the dynamically assigned Internet address of one Appliance 300A-C changes and this prevents the other appliance from reaching the changed Appliance 300A-C using the earlier Internet address.

When an Appliance 300A-C fails to connect to another already introduced Appliance 300A-C at the known Internet address, it contacts the NSI 200 to find the new location of the target Appliance 300A-C. The Appliance 300A-C will continue to periodically check with the NSI 200 until the Internet address provided by the NSI 200 proves to be useful in contacting the target Appliance 300A-C.

When any Appliance 300A-C detects a failure or a “resetting” event for itself, such as being restarted, having the Internet address changed, or the like, it performs a registration with the NSI 200. This updates the NSI 200 with the information needed by other appliances to reach the registered appliance.

If an Appliance 300A-C is known to be compromised (theft or other malicious event), the NSI 200 can immediately remove the compromised appliance from the list of known appliances, thus preventing other appliances from interacting with the compromised appliance or vice-a-versa. Such prohibition of communications for any source other than one in the list of known appliances may be implemented at any level, including, but not limited to the application's refusal to process any such communication or dynamically configuring software or hardware firewall mechanisms to ignore communications from unknown appliances and sources.

The NSI 200 can also send a message to all the other appliances (since it knows the location of each of the appliances) notifying them of the compromise, thus causing them to clear their respective available appliance lists.

In one embodiment, end users may perform trusted communications with each other as follows. A central repository, called the Entity Master Index 275 is maintained in the NSI 200 which contains the list of all the trusted end-users in the network. This list of trusted end-users may be referred to as the “Global Address Book” of the system.

In addition to the address book, a “Location Map” list is also maintained as part of the Entity Master Index 275 at the NSI 200 which associates each end user with the different appliances where the respective end user is located. For example, Dr. John Smith is a physician with details present in the Global Address Book. However, Dr. Smith may practice at two separate locations, Clinic A and Clinic B. In this case, besides having his name and address shown in the Global Address Book, Dr. John smith may also have two records in the “Location Map”, one associating him with Clinic A and the other associating him with Clinic B.

The Global Address Book as well as the Location Map may be optionally propagated to the individual appliances 300A-C periodically by the NSI 200.

At each Appliance 300A-C, an administrator may map the local appliance users to one or more entities in the Global Address book. This is the Local Identity Map (not shown).

When a user requires sending a secure message to another user in the network, he/she performs a lookup in the Global Address Book to select the recipient(s) of the message. When the message is sent, the underlying secure communications subsystem uses the Location Map to determine the Appliance 300A-C to which the message needs to be routed, and sends the message optionally in an encrypted form.

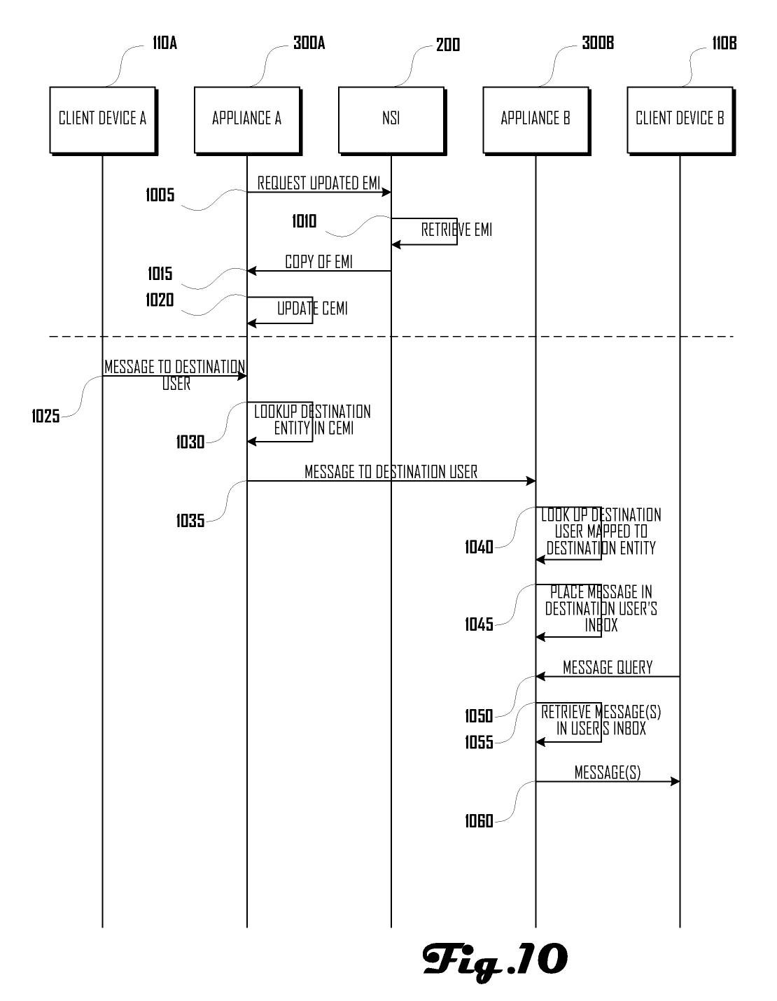

At the receiving end, the receiving Appliance 300A-C looks up the Local Identity Map to determine which end user(s) of the appliance are mapped to the Global Address Book entry to which the message is addressed. Once it finds the appliance user(s) mapped to the recipient(s), it copies the message to the inbox of the recipient user(s), who then has access to the secure communication (see FIG. 10, and description below).

In the context of a healthcare scenario, the components in FIG. 1 may correspond to the following specific instances. Each organization may correspond to healthcare providers, health-related services or other entities that deal with and needs to exchange healthcare related information. Each Appliance 300A-C may correspond to the hardware on which the software services that, in addition to other functions enable communication between the corresponding organization and other organizations in the network.

Client devices 110 may correspond to computing device, programs or web portals that expose the information and functionality of the system 100 to end users or those programs or software systems that exchange data between the system and other internal information systems at an organization.

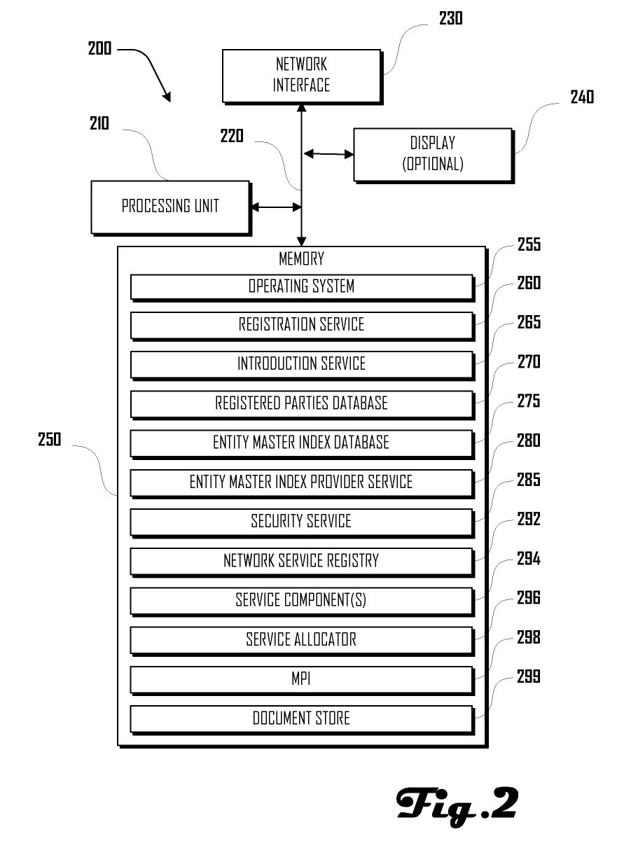

To show the operations of such communication networks, FIG. 1 illustrates an exemplary integrated secure communication system 100 having a number of devices used in exemplary embodiments. FIG. 1 illustrates a Network Service Infrastructure Device (“NSI”) 200 (illustrated in FIG. 2 and described below), a first and second appliance 300A,300B (illustrated in FIG. 3 and described below), a network 150, such as a wired or wireless communications network, and an external device 120. Also in communication with the appliances 300A-C are a number of client devices 110.

In alternate embodiments, there may be more appliances 300, NSI 200 or client devices 110. In further embodiments, the roles of one or more of an appliance 300, client device 110, NSI and/or an external device 120 may be performed by an integrated device (not show) or may be distributed across multiple other devices (not shown). In still further embodiments, still additional devices (not shown) may be utilized in the communication system 100.

In one example embodiment, different components of the system 100 may be used in a healthcare scenario, enabling interaction between different organizations using the Internet in a secure and trusted fashion. For example a hospital could use Appliance A 300A, and a physician could use Appliance B 300B (other practice, and labs may be included in more complicated scenarios) to collaborate securely with one another over the Internet 200. All of the above Appliances 300A-C may use the NSI 200 for coordinating the communication between them.

FIG. 2 illustrates several components of an exemplary NSI 200. In some embodiments, the NSI 200 may include many more components than those shown in FIG. 2. However, it is not necessary that all of these generally conventional components be shown in order to disclose an illustrative embodiment. As shown in FIG. 2, the NSI 200 includes a network interface 230 for connecting to the network 150. Those of ordinary skill in the art will appreciate that the network interface 230 includes the necessary circuitry for such a connection and is constructed for use with the appropriate protocol.

The NSI 200 also includes a processing unit 210, a memory 250 and may include an optional display 240, all interconnected along with the network interface 230 via a bus 220. The memory 250 generally comprises a random access memory (“RAM”), a read only memory (“ROM”), and a permanent mass storage device, such as a disk drive. The memory 250 stores program code for registration service 260, introduction service 270, registered parties database 270, entity master index database 275, entity master index provider service 280, and security service 285. In addition, the memory 250 also stores an operating system 255. It will be appreciated that these software components may be loaded from a computer readable medium into memory 250 of the NSI 200 using a drive mechanism (not shown) associated with a computer readable medium, such as a floppy disc, tape, DVD/CD-ROM drive, memory card, via the network interface 230 or the like.

Although an exemplary NSI 200 has been described that generally conforms to conventional general purpose computing devices, those of ordinary skill in the art will appreciate that a NSI 200 may be any of a great number of devices capable of communicating with the network 150 or with the appliances 300.

FIG. 3 illustrates several components of an exemplary appliance 300. In some embodiments, the appliance 300 may include many more components than those shown in FIG. 3. However, it is not necessary that all of these generally conventional components be shown in order to disclose an illustrative embodiment. As shown in FIG. 3, the appliance 300 includes a network interface 330 for connecting to the network 150. Those of ordinary skill in the art will appreciate that the network interface 330 includes the necessary circuitry for such a connection and is constructed for use with the appropriate protocol.

The appliance 300 also includes a processing unit 310, a memory 350 and may include an optional display 340, all interconnected along with the network interface 330 via a bus 320. The memory 350 generally comprises a RAM, a ROM, and a permanent mass storage device, such as a disk drive. The memory 350 stores program code for appliance service 360, communication service 365, security service 370, introduced parties database 375, entity master index propagation service 380, cached entity master index 385, and message inbox(es) 390. It will be appreciated that these software components may be loaded from a computer readable medium into memory 350 of the appliance 300 using a drive mechanism (not shown) associated with a computer readable medium, such as a floppy disc, tape, DVD/CD-ROM drive, memory card, via the network interface 330 or the like.

Although an exemplary appliance 300 has been described that generally conforms to conventional general purpose computing devices, those of ordinary skill in the art will appreciate that an appliance 300 may be any of a great number of devices capable of communicating with the network 150 or with NSI 200.

FIGS. 4-11 illustrate exemplary steps to process secure communications in an exemplary secure communication system 100. Some transactions in the secure communication system 100 may be more or differently networked than others. Accordingly, in some embodiments, the number and types of devices may vary.

Appliance Registration:

When two appliances 300A-C from different organizations desire to communicate between themselves, they use the authenticated and introduced model of communication to accomplish it. Before such communication can work, the system needs to ensure that each appliance is registered with the NSI 200. This is achieved by the process of appliance registration.

FIG. 4 depicts an exemplary registration process for Appliance A 300A and Appliance B 300B. On startup, the Appliance Service application 360 on Appliance A 300A sends 405 a request to the Registration Service 260 on the Network Service Infrastructure 200 to register itself. When the Registration Service 260 receives a request, it authenticates 410 the certificate associated with the appliance and if found to be authentic, updates 415 the Registered Parties Database 270.

A similar series of steps are performed for other appliances such as Appliance B 300B. Appliance B 300B sends 420 a request to the Registration Service 260 on the Network Service Infrastructure 200 to register itself. When the Registration Service 260 receives a request, it authenticates 425 the certificate associated with the appliance and if found to be authentic, updates 430 the Registered Parties Database 270.

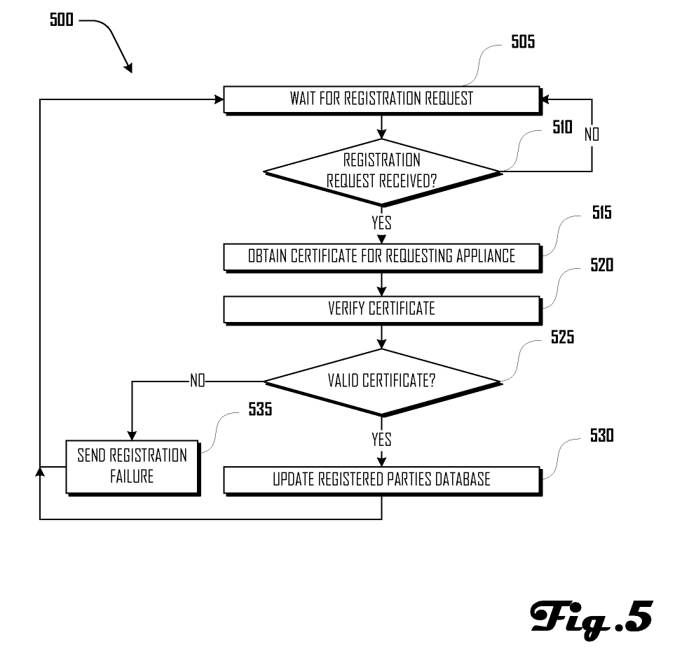

FIG. 5 illustrating an exemplary registration routine 500 on the NSI 200. Registration routine 500 begins at block 505 where the routine 500 waits for a registration request (e.g., from an Appliance 300). Next, in decision block 510 a determination is made where a registration request was received, if so, processing proceeds to block 515. Otherwise processing cycles back to block 505.

In block 515 a digital certificate of the requesting appliance 300 is obtained. In block 520, the certificate is verified. Next, in decision block 525 a determination is made whether the certificate is valid (e.g., corresponds to the requester, has not been revoked, has not expired and the like). If the certificate is valid, process continues to block 530, where the registered parties database 270 is updated with the appliance's certificate. If the certificate was not valid, a registration failure is sent to the requester in block 535. Routine 500, in any case, cycles back to block 505 where it waits for a new request.

Introduction and Communication:

Once two appliances have been introduced, they may communicate with each other. The origin appliance can begin to communicate with the destination appliance as long as both of them continue to use the same Internet address. A reintroduction is initiated if any of the appliances experiences a change in the Internet address, or any other failure during the course of communications. This mode of introduced communications is depicted by FIG. 6.

In FIG. 6, when appliance A 300A desires to communicate with Appliance B 300B, the address of which is not known, the following are the sequence of events that take place. Appliance A 300A requests 605 of the Introduction service 265 in the NSI 200 to be introduced to appliance B 300B. Introduction service 265 looks up 610 the Registered Parties Database 270 to find the address of appliance B 300B. Introduction service 265 then contacts 615 Appliance B 300B with information about Appliance A 300A. Appliance Service 360 on Appliance B 300B enters 620 the address of Appliance A 300A into its own Introduced Parties Database 375.

Application Service 360 might also perform additional activities such as configuring other mechanisms (such as a configurable software or hardware firewall) that aid in filtering out communications from unknown sources.

Introduction service 265 obtains an introduction confirmation and forwards 625 the result of the introduction process to Appliance A 300A, also including the current contact address of Appliance B 300B. Appliance A 300A registers 630 the address of Appliance B 300B in its Introduced Parties Database 375. Communication service 365 at Appliance A 300A sends 635 the communication/message to the Communication service 365 at Appliance B 300B. Communication service 365 at Appliance B 300B looks up and validates 640 the address of Appliance A 300A in its local Introduced Parties Database 375, finds the source of the communication to be valid and handles 645 the message.

This introduced mode of communication serves a number of purposes. It ensures that any change in the address of a node does not cause inter-node communications to fail. It also ensures that in case of a node being compromised, it can be isolated from the rest of the network. Additionally, it also ensures that the identity of each node is authenticated before any other nodes are allowed to communicate with it, as well as before it is allowed to communicate with any other node.

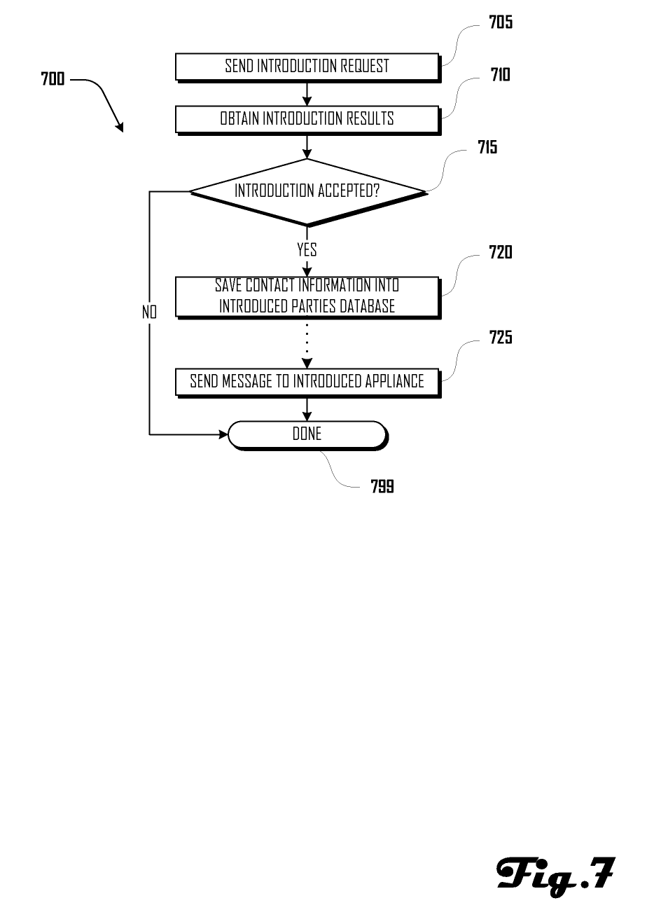

FIGS. 7-9 illustrate exemplary flow diagrams of the processes performed at devices within the system 100 to communicate a secure message.

FIG. 7 illustrates an exemplary flow diagram of an introduced communication routine 700 performed at a requesting appliance to initiate a secure communication with a destination appliance. Introduced communication routine 700 begins at block 705, where an introduction request is sent to a trusted introduction device (e.g., the NSI 200 or the like). The results of the introduction request are obtained in block 710. Next, in decision block 715, a determination is made whether the introduction was accepted. If so, in block 720 the contact information for the destination appliance is saved into the introduced parties database 375. If not, processing would proceed to block 799.

Once the contact information of the destination appliance has been saved, at some future point, as shown in block 725, a message may be sent to the introduced appliance. Routine 700 ends at block 799.

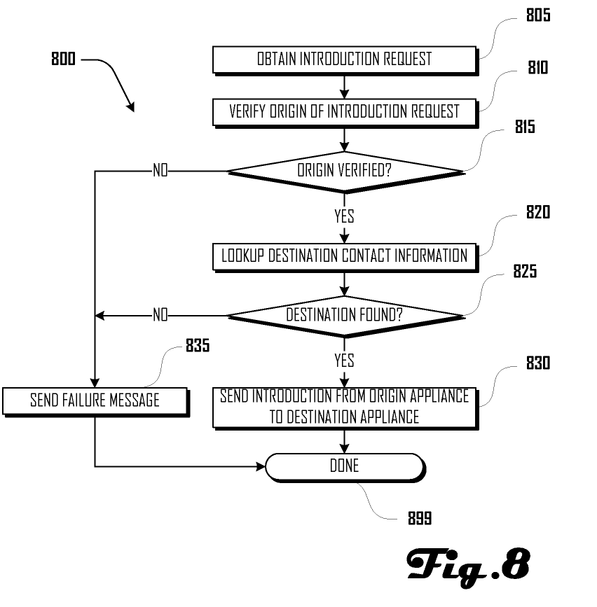

FIG. 8 illustrates an exemplary flow diagram of an introduced communication routine 800 performed at the NSI 200 to facilitate a secure communication with a destination appliance. Introduced communication routine 800 begins at block 805 where an introduction request is obtained. In block 810, the origin of the introduction request is verified (e.g., by checking the registered parties database 270). If the origin is verified, as determined in decision block 815, processing proceeds to block 820, where the destination appliance's contact information is looked up. If the origin was not verified, processing would proceed to block 835, where a failure message would be sent to the requester and routine 800 would end at block 899.

If a destination's contact information was looked up successfully, as determined in decision block 825, processing proceeds to block 830, where an introduction of the requester appliance is sent to the destination appliance and processing proceeds to block 899. If a destination's contact information was not found, as determined in decision block 825, processing would proceed to block 835 as noted above.

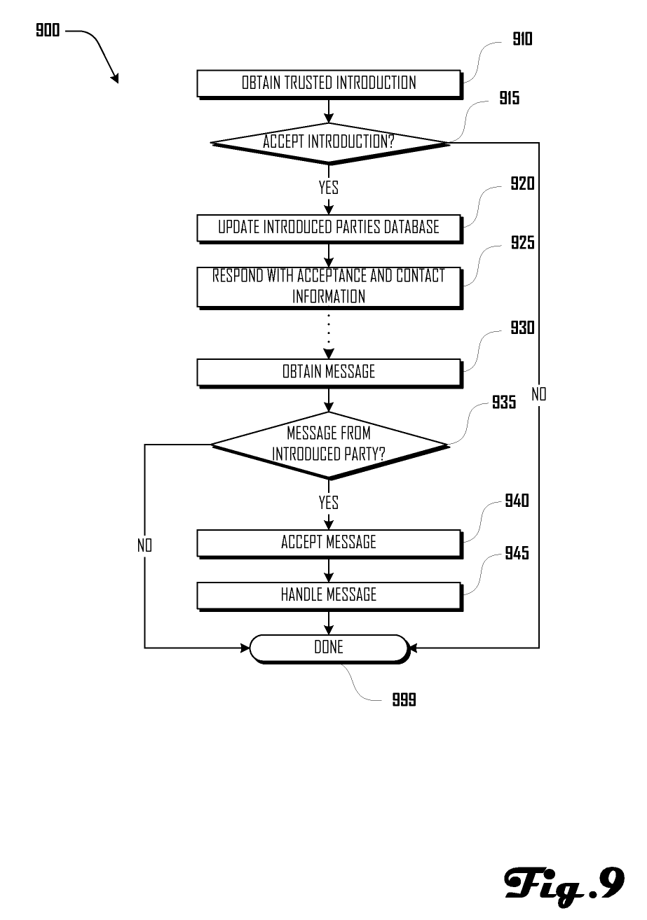

FIG. 9 illustrates an exemplary flow diagram of an introduced communication routine 900 performed at a destination appliance. Routine 900 begins at block 910 where a trusted introduction is obtained (e.g., from NSI 200, or the like). If, as determined in decision block 915, the introduction is accepted, processing proceeds to block 920. Otherwise, processing proceeds to block 999, where routine 900 ends.

In block 920, the introduced parties database 375 is updated with the contact information of the origin appliance requesting the introduction. In block 925, an introduction acceptance is sent to the origin appliance.

At some point, a message may be obtained (e.g., from the introduced origin appliance), as show in block 930. In decision block 935 a determination is made whether the message came from an introduced party (e.g., do they exist in the introduced parties database 375). If the message came from an unknown party, processing would simply proceed to block 999. Otherwise, if the appliance sending the message had been introduced, processing would proceed to block 940, where the message would be accepted. In block 945 the destination appliance would handle the message and processing would end at block 999.

Person to Person Communications:

The inter-appliance communications described above may be leveraged by a secure person-to-person communication infrastructure described below. This exemplary embodiment of person-to-person communications supplements the introduced communications mechanism explained above.

This person-to-person communications may use the Entity Master Index 275 (“EMI”). The EMI 275 enables each Appliance 300A-C to expose to its client devices 110 the list of bona fide providers in the secure communications system 100, in order to enable a client 110 to address a secure message to any client 110 in the secure communications system 100. This enables any authorized user in the system to send a message to any other trusted and advertised provider. Before any entity can receive a secure message from another, information about the identity and location of that entity should be entered in the EMI 275.

The EMI 275, in some embodiments, has two parts: a Global Entity List (“GEL”) and the Location Map (not shown). The GEL (not shown) is a list of all users in the system 100. These correspond to the different trusted persons and other human-addressable entities in the system 100. In some embodiments, entries in the GEL list are created only after extensive verification of the identity and credentials of the person or entity, including reference checks where applicable. This ensures the trustworthiness of the entries in the GEL.

The Location Map contains a mapping of each provider to one or more appliances 300A-C in the secure communications system 100. Given the identity of any entity in the network, this enables any Appliance 300A-C to determine the peer appliance to which secure messages addressed to that entity should be directed.

The Security and Role Repository (not shown) contains the identities of all the end users of the Appliance 300A-C and the roles assigned to them. Additionally, for each end user, it also enables the administrator to assign one or more user identities from the GEL, thus declaring that global entity to be assigned to the local end user.

In order to identify and correlate entity information between different internal systems at the practice, a Cached Entity Master Index (“CEMI”) 385 may be maintained at the appliance 300. The CEMI 385 is a replica of the EMI 275 contents, including the GEL and the Location Map. This is copied periodically to each Appliance 300A-C in order to enable users using the client application to locate and select recipients for the secure messages.

Secure Person-to-Person Messaging:

FIG. 10 depicts how person-to-person secure messaging is performed with a combination of the EMI 275 and secure trusted appliance communications described above.

Replication of the Entity Master Index:

At regular intervals, the Entity master index Propagation service 380 on Appliance A 300A requests 1005 updates to the EMI 275 information. The EMI Provider Service 280 on NSI 200 retrieves 1010 the latest information from the Entity Master Index database 275. The updated EMI information is returned 1015 to Appliance A 300A. The updates to the EMI are saved 1020 in the CEMI 385 by the EMI Propagation Service 380. Such replication of the EMI is optional and may be useful if the client devices 110 need access to the information without having to make a round trip to the original source of information at the NSI 200.

Person/Machine to Person Communication:

The following are exemplary steps that may take place when a client device A 110A connected to appliance A 300A requests to send a secure message to a person registered at a different appliance. A user using Client Device A 110A, requests 1025 a secure message to be sent to another person. Such a request to send a message to another person may not only be performed by a person, but also performed by a program using an application programming interface. The information about the appliance where the recipient entity is present is retrieved 1030 by the Secure Messaging Service 370 from the CEMI 385. Assume the destination user/recipient is registered at appliance B 300B. The secure Messaging Service 370 calls the Communication service 365 to send a secure message to Appliance B 300B. Using the secure introduced communication mechanism, the Communication service 365 on appliance A sends 1035 the message to the Communication service 365 on appliance B 300B. The Communication service 365 on Appliance B 300B passes the message to the secure messaging service 370 on the same appliance. The secure messaging service 370 consults 1040 the CEMI 385 to retrieve the entity at Appliance B 300B who is associated with the person to whom the message is addressed. The secure messaging service 370 places 1045 the secure message in the Message Inbox 390 with the recipient user ID set to the local user to whom the person is mapped. The recipient user, using the client device B 110B, associated with Appliance B 300B, requests 1050 to view the incoming secure messages. The request is sent to the Secure messaging Service 370. Secure messaging service 370 retrieves 1055 the incoming messages from the Message Inbox 390, which includes the new message that has arrived for that user. Secure messaging service 370 returns 1060 the incoming message(s) to client B 110B, where the recipient user receives and views the secure message.

As an alternative, the person sending or receiving a secure message may be replaced by a software program or other device that is designed to do so, on a person's/entity's behalf.

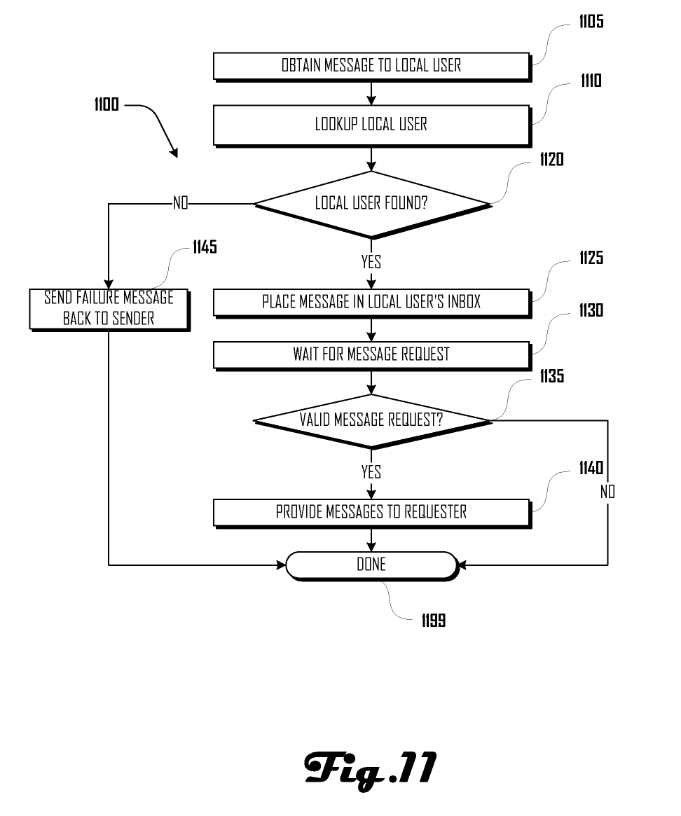

FIG. 11 illustrates an exemplary flow diagram of a person-to-person introduced communication routine 1100 performed at the receiving appliance to facilitate a secure communication to a destination user. Routine 1100 begins at block 1105, where a message to a local user is obtained. In block 1110 the local user is looked up. If, as determined in decision block 1120, the local user is found, processing proceeds to block 1125. Otherwise, a failure message is sent back to the message sender in block 1145 and routine 1100 ends at block 1199.

In block 1120 the message is placed in the user's inbox 390 on the receiving appliance. Routine 1100 waits in block 1130 until a message request is received. Once a valid message request is received, as determined in decision block 1135, the message(s) in the user's inbox 390 are provided to the requester in block 1140. After the messages have been received, or if the message request was invalid, routine 1100 ends at block 1199.

In addition to messages, organizations would like to leverage the ubiquitous and inexpensive Internet for providing services that are commonly used by multiple entities. For example different branches of an organization in the financial services industry may want to use a common set of services for performing financial modeling for customer accounts. In the healthcare industry, two physicians may want to share the same common Data services to convert healthcare information to a common format. Multiple intelligence agencies may want to use a set of shared services to analyze fingerprints to identify matching individuals. In addition to coordinating the communications between different nodes, the NSI 200 may also include a list of registered service providers, such as within a Network Service Registry 292 along with additional information pertaining to each of the services they expose. This additional information may include, but is not limited to, the current utilization of the service, the configuration information about the service, the load being applied on the service and the availability of the service. These attributes of a service provider may be used by a prospective consumer of the service (For example, Appliance B 300B) to determine which service provider in the system 100 should be invoked to perform the specific service it requires. Additionally, the NSI 200 includes a list of patients and the practices where they have been registered. This list of practices and patients is termed the Master Person Index 298 or “MPI”. The MPI 298 is a repository of patients' relevant demographic information which can be used to quickly lookup any patient by the name, social security number or other identifying information. Once a patient is found, the MPI 298 also has the ability to provide information on the different appliances in the network where the patients' data can be found.

In one exemplary embodiment illustrated in FIG. 1, any given set of sites/Appliances A-B 300A-C communicating and collaborating with each other in a peer-to-peer fashion can utilize one of the Service Components (294, 394) to perform transformation of data from a given set of source formats to a given set of destination formats.

Such utilization of shared resources (Data services is an example of such a resource) can be achieved by the nodes (appliances 300 or their clients 110) in the system 100 without regard to the actual location/appliance where these actual services are present and available. In addition, the lack of availability of any of the Data service instances can be accounted for by the system 100 by routing the requests for such services to the ones that are available.

Network Service Registry:

The network service registry 292 is a collection of information about the different services that exist in the entire network. This is kept up-to-date by each service component (294, 394) at regular intervals, to maintain an accurate list of services available and additional information corresponding to each service.

Local Service Registry:

The local service registries 392 are repositories of information about the different services that are available in the respective local appliance or the NSI 200. The local service registry 392 is kept up-to-date by each local service component 394 of the Appliance 300, at regular intervals, to maintain an accurate list of services available and additional information corresponding to each service.

Service Registration:

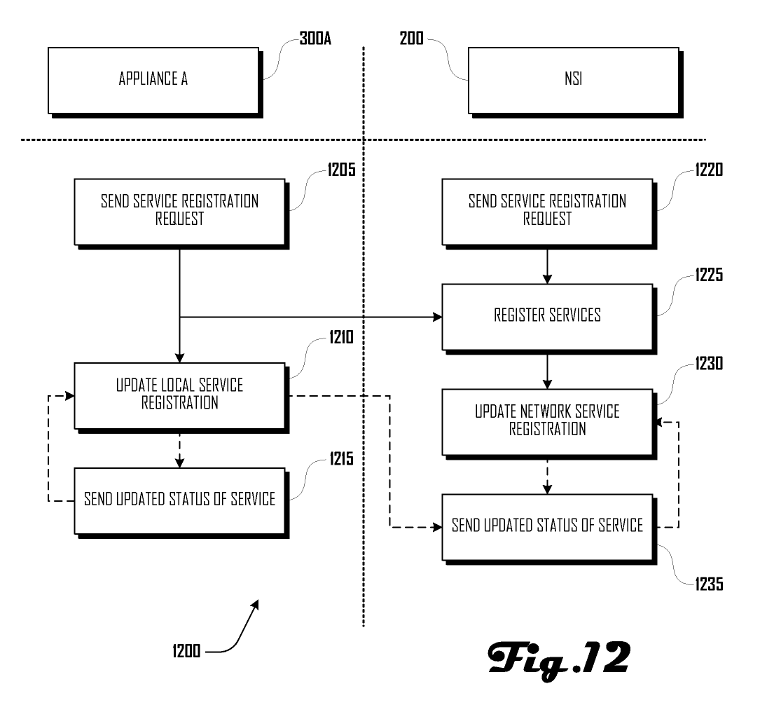

FIG. 12 illustrates an exemplary process of registering a service in the system 100. When the Service components (294, 394) start, each of them sends a request (1205, 1220) to the NSI 200, which in turn registers the services (1225) in the Network Service Registry 292. Service component 394 also updates (1210) the Local Service Registry 392 directly, updating information about itself that only prospective consumers on the local appliance 300A can access. Likewise Network Service component 294 also updates (1230) the Network Service Registry 292 directly, updating information about itself that networked prospective consumers connected to the NSI 200 can access. Once the service registration is performed, each of the service components (294, 394) may be available to accept service requests from any (or a restricted set) of prospective consumers of their services.

At regular intervals, or when specific events occur, each service component (294, 394) may send (1215, 1235) updates status information about themselves to the Local Service Registry 392 as well as the Network Service Registry 292. These specific events may include, but are not limited to, the receipt of a request for processing, the completion of a request, shutting down of the service etc. The additional information sent to the Network Service Registry 292 and the Local Service registry 392 may include but is not restricted to, the number of requests processed by the service, information about the average time the respective service takes to process a request, local resource availability, and the state of the service (Active/Inactive/Paused/Processing are some examples of service state).

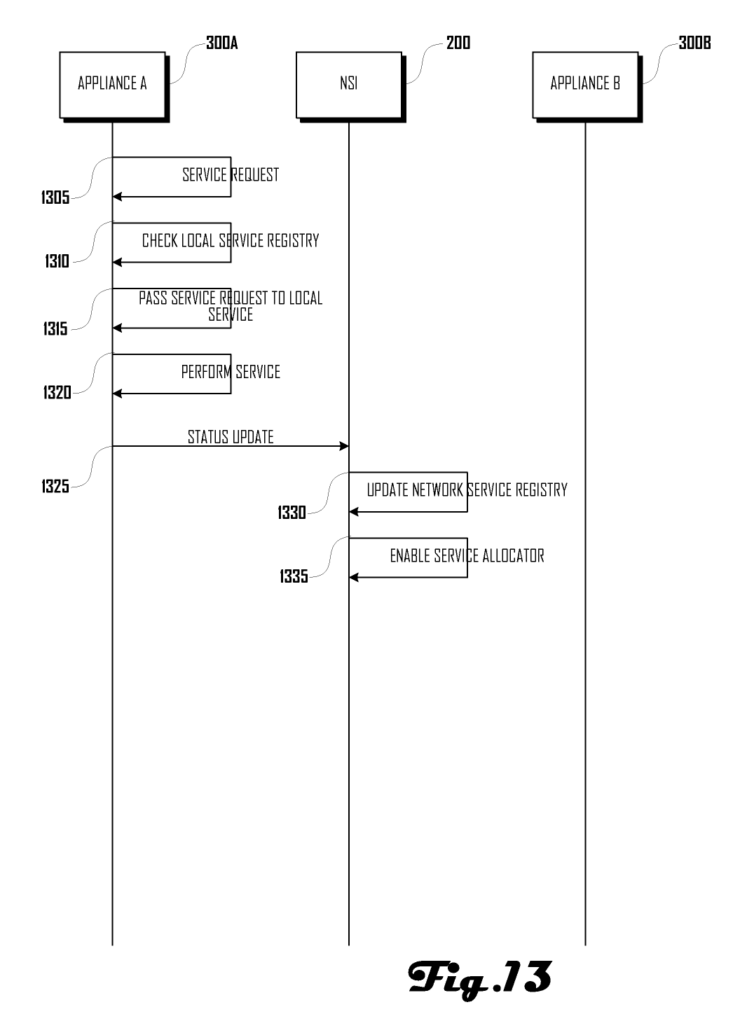

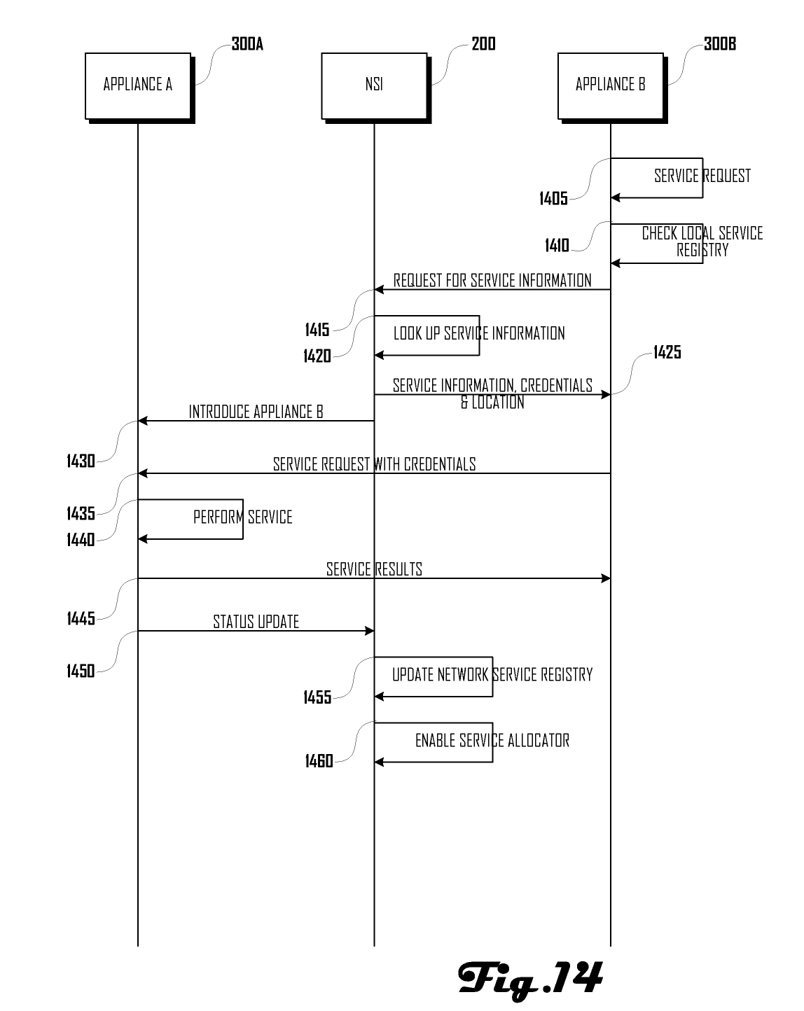

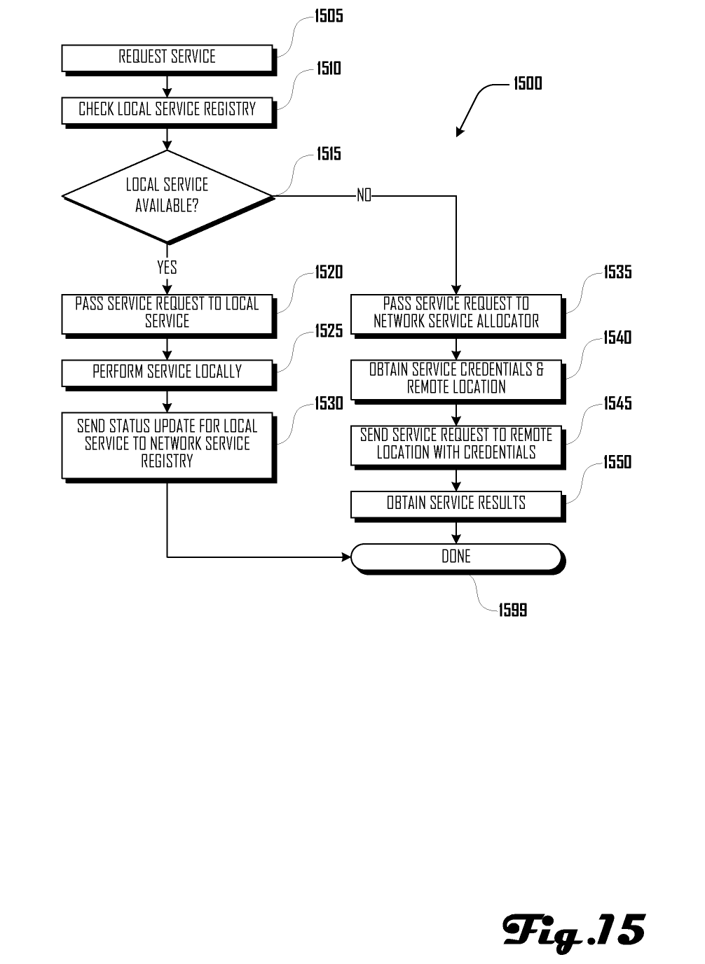

The architecture of example devices that consume Data services are shown in FIGS. 13-14

Processing Using a Local Service:

FIG. 13 illustrates processing a local service. When a Client 110 requests to perform a service, it requests 1305 the service. The Appliance A 300A checks 1310 the local service registry 392 to determine that the local system already has a running instance of the Service component 394 that matches the requested service. Next the local service component 394 is passed 1315 the inputs to perform the requested service. The Service Component 394 takes the provided inputs, performs 1320 the requested processing and if the processing is successful, returns the result to the Client 110. If the processing failed for some reason, the error information is returned to the Client 110.

Optionally, once the processing is completed by the Service Component 394, Appliance A 300A may send 1325 an update to the Network Service Registry 292 (and/or the Local service Registry 392) with information such as current load on the service component 394, the number of requests processed and the availability or status. Such updates may be optional, and the service may perform these updates at regular intervals, after processing each request, after processing a number of requests, or never at all. When such an update is received by the NSI 200, it updates 1330 the information about the service into the Network Service Registry 292, which subsequently may enable 1335 the Service Allocator 296 to make allocation decisions with the most current information.

Processing Using a Remote Service:

FIG. 14 illustrates processing a local service. When a Client 110 of Appliance B 300B which does not have a local service available requires a service, it may make a request 1405 on the local appliance, Appliance B 300B for the service. The Appliance B 300B makes a decision of which actual instance of Service in the system 100 the request will be routed to and processed by. While it does not necessarily perform the requested service, it may hold the responsibility of first determining the location of correct service to use, and forwarding the request to an appropriate service implementation at the chosen location. It may also be responsible for receiving the result of the processing and passing it back to the entity that requested the service.

The example of FIG. 14 shows the sequence of events that happen when a Client 110 requests a service and Appliance B 300B does not have the service available (e.g., there is no instance of the desired service component 394 on Appliance B 300B). Additionally, this example illustrates the case when the Service Allocator 296 determines that the Service Component 394 on Appliance A 300A is the optimal service component 394 to use. A similar sequence of events may occur if the service is performed by a Service Component 294 hosted on the NSI 200.

When a Client 110 of Appliance B 300B requests 1405 to perform a service, Appliance B 300B determines, by checking 1410 in the Local Service Registry 392) that there is no available service on Appliance B 300B. This causes Appliance B 300B to contact 1415 the Service Allocator 296 component in the NSI 200, with a request to provide information on the most appropriate service component to use. The Service Allocator 296 receives the request, the parameters of which may include, but are not limited to those that describe the type of service requested, the amount of data that needs to be passed to the service and the location from where the call originated. With these parameters, it looks up 1420 in the Network Service Registry 292 to determine the most appropriate service to use. This determination may be based on various factors including, but not limited to, the type of service requested, the desired configuration of service instance, availability of the service instance, proximity to the requesting service, number of outstanding requests to the service instance, average turn-around times for the service instance. Based on one or more of the actual factors used in the selection, the Service Allocator 296 returns 1425 to Appliance B 300B, the location and credentials of the selected service to be used, along with an optional count of the number of requests that may be forwarded to the selected Service Instance. This is to avoid Appliance B 300B from having to contact the Service Allocator 296 too frequently for each request it needs to process. The Service Allocator 296 may additionally perform an introduction 1430 of the requesting appliance (Appliance B 300B) to the appliance on which the service instance is running (Appliance A 300A).

When Appliance B 300B receives the address and credentials for the selected service (assume Service Component 394 on Appliance A 300A is selected) from the Service Allocator 296, Appliance B 300B may send 1435 the service request in a secure and trusted manner to the corresponding Service Component 394 at the destination appliance (Appliance A 300A). The Service Component 394, in turn performs the service 1440, and returns 1445 the results on successful completion or error information on a failure back to Appliance B 300B.

Optionally, once the processing is completed by the Service Component 394, Appliance A 300A may send 1450 an update to the Network Service Registry 292 (and/or the Local service Registry 392) with information such as current load on the service component 394, the number of requests processed and the availability or status. Such updates may be optional, and the service may perform these updates at regular intervals, after processing each request, after processing a number of requests, or never at all. When such an update is received by the NSI 200, it updates 1455 the information about the service into the Network Service Registry 292, which subsequently may enable 1460 the Service Allocator 296 to make allocation decisions with the most current information.

In some embodiments, when any Appliance 300A-C detects a failure or a “resetting” event for itself, such as being restarted, having the Internet address changed, or the like, it performs a registration (see FIG. 12) of all the locally available services (Example: Service Component 394) on the NSI 200. This updates the Network Service Registry 292 on the NSI 200 with the current information needed by other appliances to discover the registered service.

FIG. 1 shows the different clinical devices that come into play in an exemplary clinical scenario utilizing the invention. Each of the appliance 300A-C are potential locations where patients may be registered from and documents such as Consult Reports, medication information, Clinical Notes and the like may be generated for any of the registered patients. The NSI 200 may include the MPI 298, an optional central document store 299 and an optional central document store 299. The central document store 299 is optional in the sense that the invention may fulfill its purpose without the necessity to have a central repository. The presence of a central repository however may enhance the functionality of the system by providing an additional safeguard to the entire system.

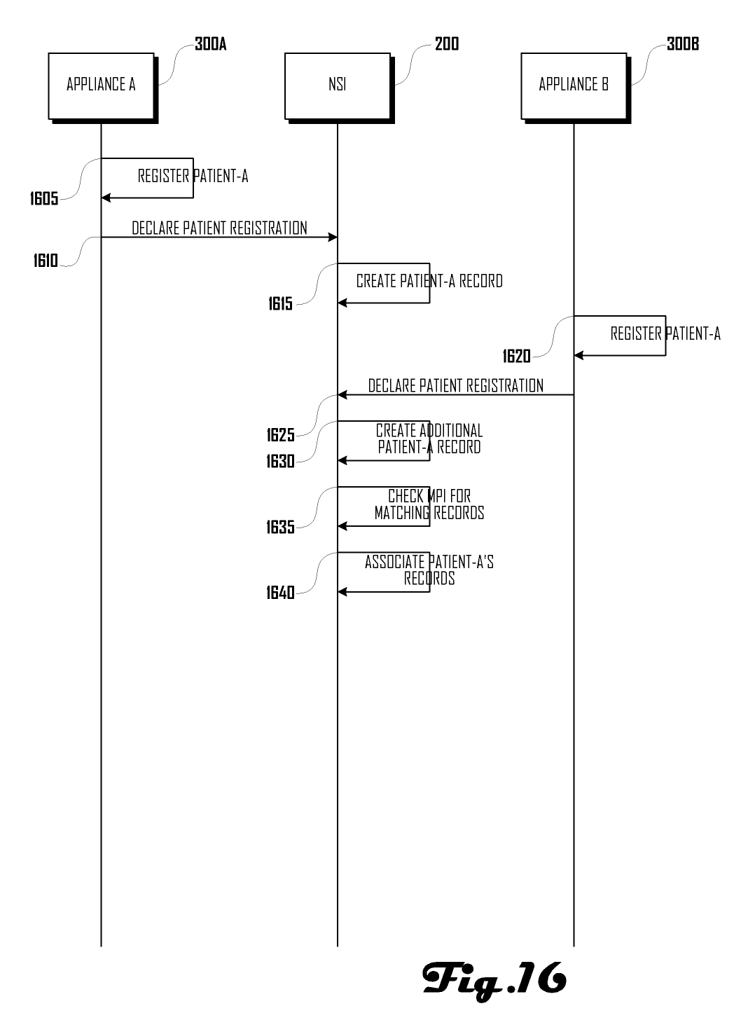

FIG. 16 shows the process by which the same patient PATIENT-A is registered at different practices (appliances). When the patient is registered 1605 at the practice of Appliance A 300A, Appliance A 300A declares 1610 the registration to the NSI 200. The NSI 200 creates 1615 a patient record in the MPI 298 with information about the registered patient, along with the fact that the particular patient information was received from Appliance A 300A.

When the same patient PATIENT-A is registered 1620 at a Physician Practice associated with Appliance B 300B, Appliance B 300B declares 1625 the registration to the NSI 200. The NSI 200 creates 1630 a record in the MPI 298 with information about the new patient registration. The NSI checks 1635 in the MPI 298 and finds that records 304 also corresponds to the same patient and associates 1640 them together in the MPI 298 database.

In addition to storing demographic information about the patient, the MPI 298 also stores a reference to the Appliance 300A-C from which the patient registration request originated. This means for any individual patient in the network, at any future point of time, the MPI 298 can provide a list of different practices/hospitals that have registered the same patient. In one embodiment, all such practices are assumed to be treating the individual patient. This list of practices in the MPI 298 for each patient may be utilized by the network when a new document is generated for the patient at any practice to determine which other practices in the network are associated with the patient.

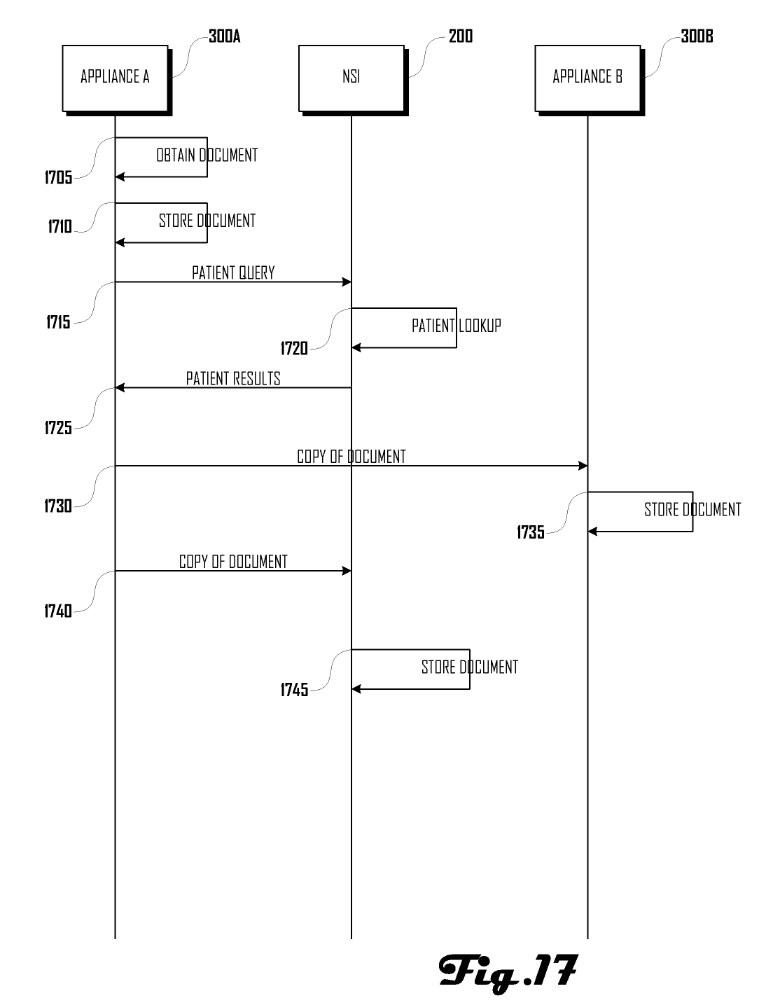

FIG. 17 shows the process that occurs when a new document (For example, a Consult Report) is obtained 1705 for PATIENT-A at Appliance A 300A. Appliance A 300A stores 1710 the newly generated document in its local document store 399. After the document has been saved in the local document store 399, Appliance A 300A then queries 1715 the NSI 200 to determine the other practices in the network that are treating the same individual patient. The NSI 200 then looks up 1720 the patient in the MPI 298 and passes 1725 the results back to Appliance A 300A. Appliance A 300A is able to determine that the Physician Practice associated with Appliance B 300B is also involved in treating PATIENT-A. Appliance A 300A sends 1730 a copy of the original document to Appliance B 300B. Appliance B 300B stores the Document Copy to its Document Store 399.

Optionally, Appliance A 300A may also send 1740 a copy of the original document to the NSI 200 with a copy of the original document. In this event, NSI 200 with save 1745 the Document Copy to the Document Store 299. In some embodiments, documents are sent to the Document Store 299 in the NSI 200 when the network 100 is not found to have a minimum number of practices where the patient in question (PATIENT-A) is registered. This is to ensure that there are sufficient reliable sources of data should any of the individual locations of care be unavailable. Once the patient is detected to be registered at more than the required minimum, such propagation of data to the Document Store 299 in NSI 200 may be stopped.

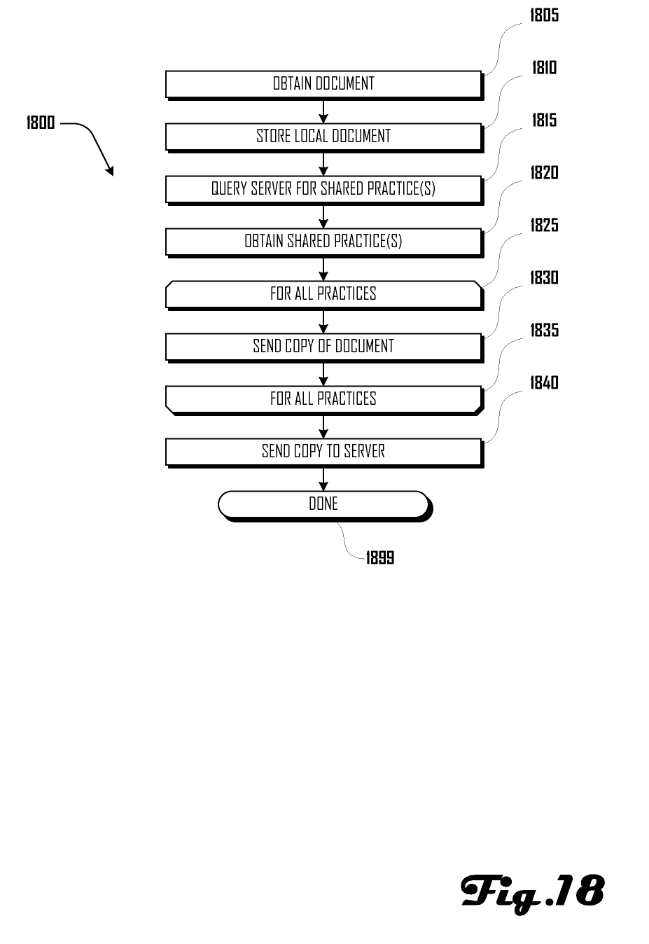

FIG. 18 is a representative flow diagram of a document handling routine 1800 for distributing a document to appropriate locations in the redundant data storage system 100. Document handling routine 1800 begins at block 1805 where a document is obtained. In block 1810 the document is stored in the document store 399. The NSI 200 is queried in block 1815 for the location of practices that share the document's patient. From the results obtained in block 1820, looping block 1825 begins iterating through each shared practice location. Block 1830 sends a copy of the document to an associated device (e.g., appliance 300) of the current practice. Looping block 1835 cycles back to looping block 1825 until all practices have been iterated through. Optionally, a copy of the document may be sent to the NSI 200 for storage in its document store 299 as shown in block 1840. Document handling routine 1800 ends at block 1899.

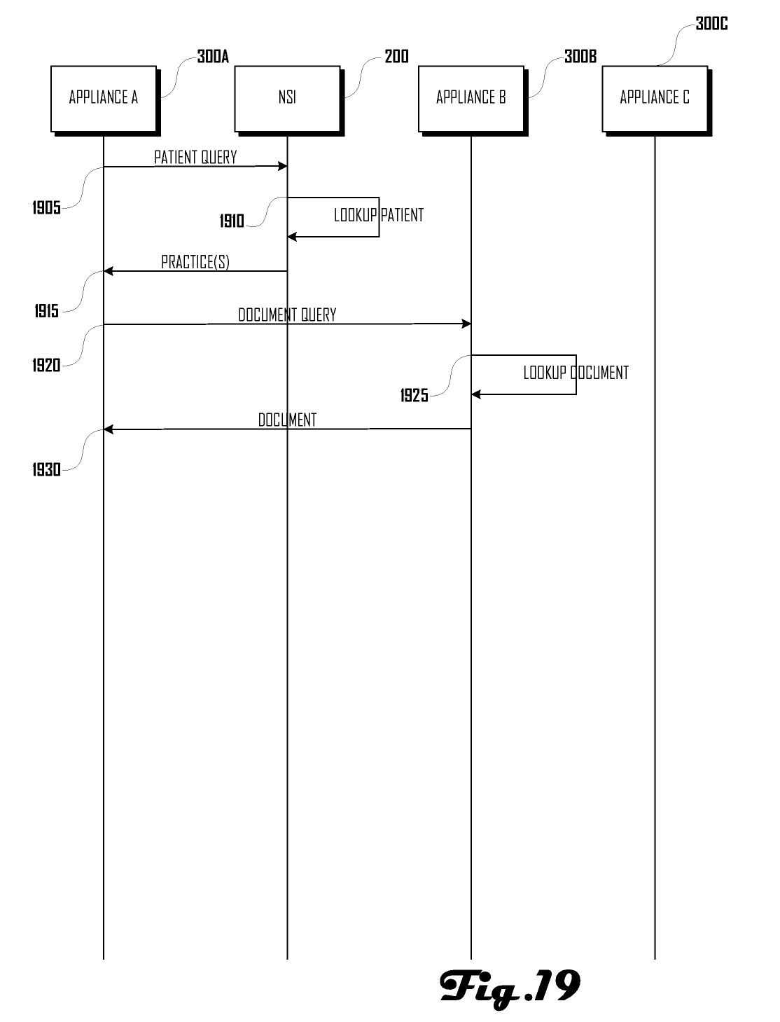

FIG. 19 depicts the process by which Appliance A 300A retrieves the document that was generated at Appliance B 300B (or some other appliance) related to PATIENT-A from the Appliance B 300B, with the precondition that Appliance B 300B is accessible from Appliance A 300A.

When a user at Appliance A 300A requests for a document for PATIENT-A that was generated at Appliance B 300B, Appliance A 300A queries 1905 the NSI 200 to determine the list of practices where PATIENT-A is registered and thus documents may be found. The NSI 200 consults 1910 the MPI 298 to retrieve the list of practices. In this specific example, the records are found to exist, signifying that Appliance B 300B has PATIENT-A registered. This information is passed 1915 back to Appliance A 300A. Appliance A 300A next performs a query 1920 to Appliance B 300B for the required document. Appliance B 300B looks up 1925 in the document store 399 to retrieve the document. Appliance B 300B returns 1930 the document to the Appliance A 300A. The Appliance A 300A may then return (not shown) the document to the user that performed the search.

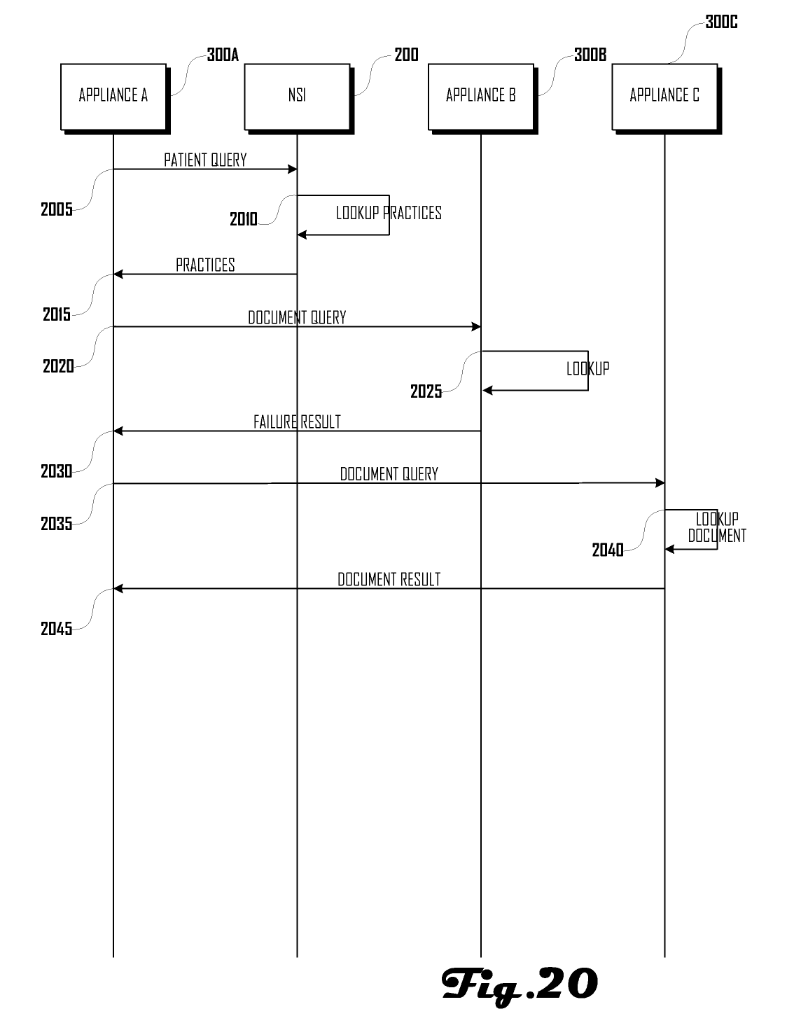

FIG. 20 depicts the process by which Appliance A 300A retrieves the document that was generated at Appliance B 300B (or some other appliance) related to PATIENT-A from the Appliance B 300B, with the precondition that Appliance B 300B is inaccessible from Appliance A 300A or no longer has the required document.

When a user at Appliance A 300A requests for a document for PATIENT-A that was generated at Appliance B 300B, Appliance A 300A queries 2005 the NSI 200 to determine the list of practices where PATIENT-A is registered and thus documents may be found. The NSI 200 consults 2010 the MPI 298 to retrieve the list of practices. In this specific example, the records are found to exist, signifying that Appliance B 300B has PATIENT-A registered. This information is passed 2015 back to Appliance A 300A. Appliance A 300A next performs a query 2020 to Appliance B 300B for the required document. Appliance B 300B looks up 2025 in the document store 399 to retrieve the document. Appliance B 300B returns 2030 a failure result to Appliance A 300A. Accordingly, Appliance A 300A next performs a query 2035 to Appliance C 300C (which was listed in the list of practices received from the NSI 200 that have the document) for the required document. Appliance C 300C looks up 2040 in the document store 399 to retrieve the document. Appliance C 300C returns 2045 the document to Appliance A 300A. Appliance A 300A may then return (not shown) the document to the user that performed the search.

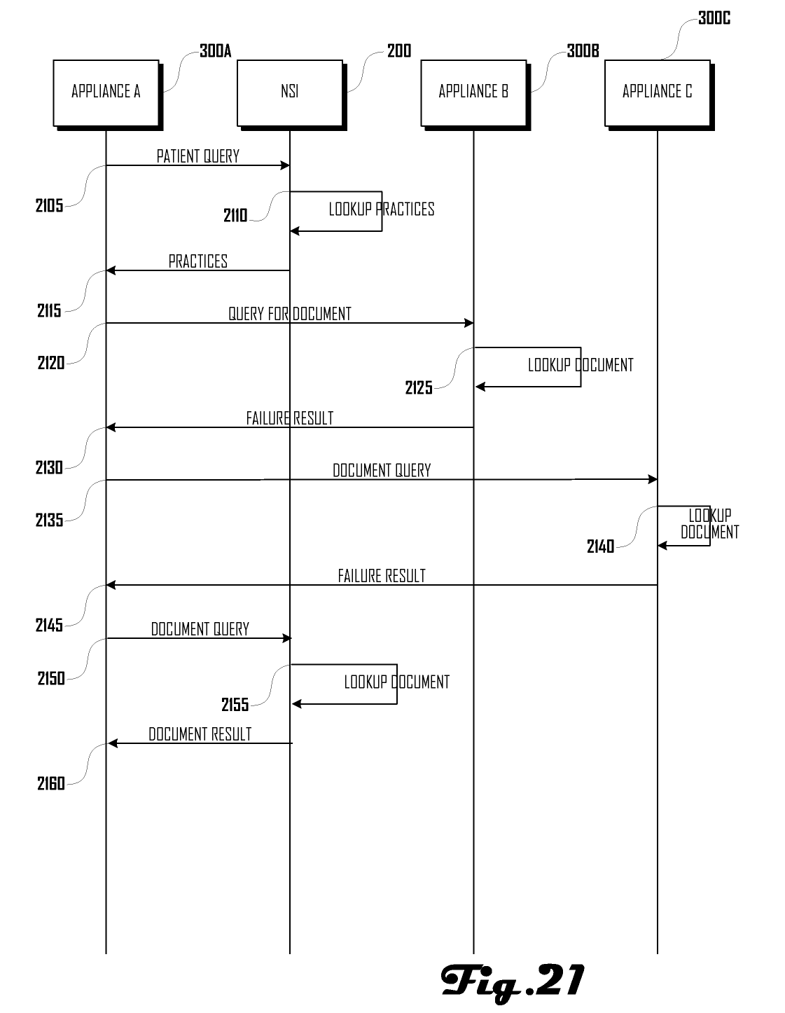

FIG. 21 depicts the process by which Appliance A 300A retrieves the document that was generated at Appliance B 300B (or some other appliance) related to PATIENT-A from the NSI 200, with the precondition that designated appliances are inaccessible from Appliance A 300A or no longer have the required document.

When a user at Appliance A 300A requests for a document for PATIENT-A that was generated at Appliance B 300B, Appliance A 300A queries 2105 the NSI 200 to determine the list of practices where PATIENT-A is registered and thus documents may be found. The NSI 200 consults 2110 the MPI 298 to retrieve the list of practices. In this specific example, the records are found to exist, signifying that Appliance B 300B has PATIENT-A registered. This information is passed 2115 back to Appliance A 300A. Appliance A 300A next performs a query 2120 to Appliance B 300B for the required document. Appliance B 300B looks up 2125 in the document store 399 to retrieve the document. Appliance B 300B returns 2130 a failure result to Appliance A 300A. Accordingly, Appliance A 300A next performs a query 2135 to Appliance C 300C (which was listed in the list of practices received from the NSI 200 that have the document) for the required document. Appliance C 300C optionally looks up 2140 in the document store 399 to retrieve the document. Appliance C 300C also returns 2145 a failure result to Appliance A 300A. Appliance A 300A next performs a query 2150 to the NSI for the same data. When the NSI 200 receives a request for a document generated at an appliance (e.g., Appliance B 300B) for PATIENT-A, it looks up 2155 in the Document store 299, and finds that a copy of the document, exits. The NSI 200 returns 2160 this copy to Appliance A 300A. Appliance A 300A may then return (not shown) the document to the user that performed the search.

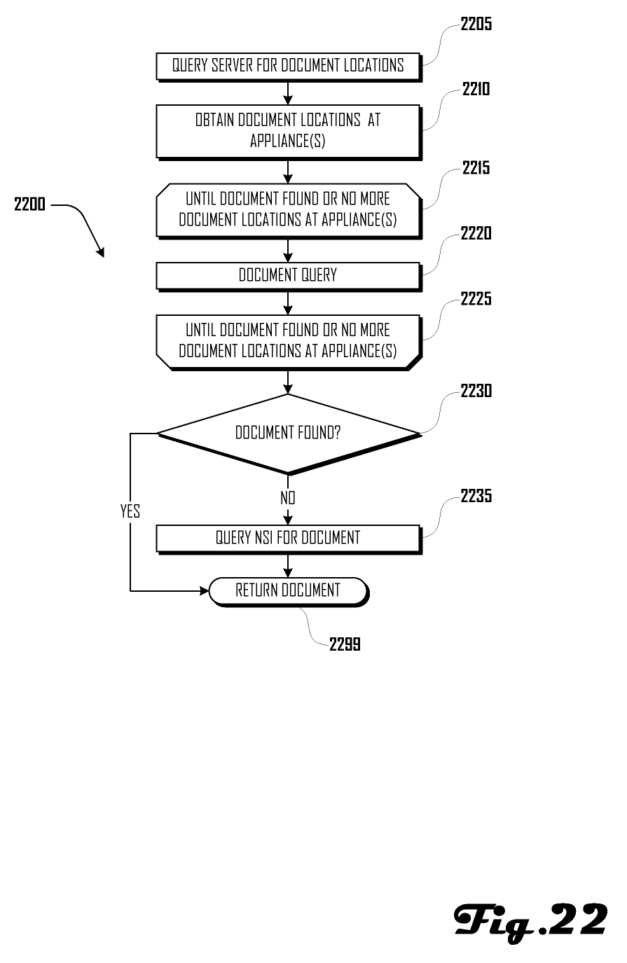

FIG. 22 illustrated an exemplary document retrieval subroutine 2200. Subroutine 220 begins at block 2205 where the NSI 200 is queried for document locations. The document locations are obtained in block 2210 from the NSI 200. Next, looping block 2215 begins an iteration for each location where the document can be found (until all have been checked, or the document is found). Block 2220 queries the current location for a copy of the document. Looping block 2225 cycles back to looping block 2215 until all locations have been checked, or the document is found, after which, processing proceeds to decision block 2230. If, in decision block 2230 it is determined that the document was found, the document is retuned to its calling routine in block 2299. If, however, the document was not found, processing proceed from decision block 2230 to block 2235 where the NSI 200 is queried for the document, which is then returned to the calling routine in block 2299.

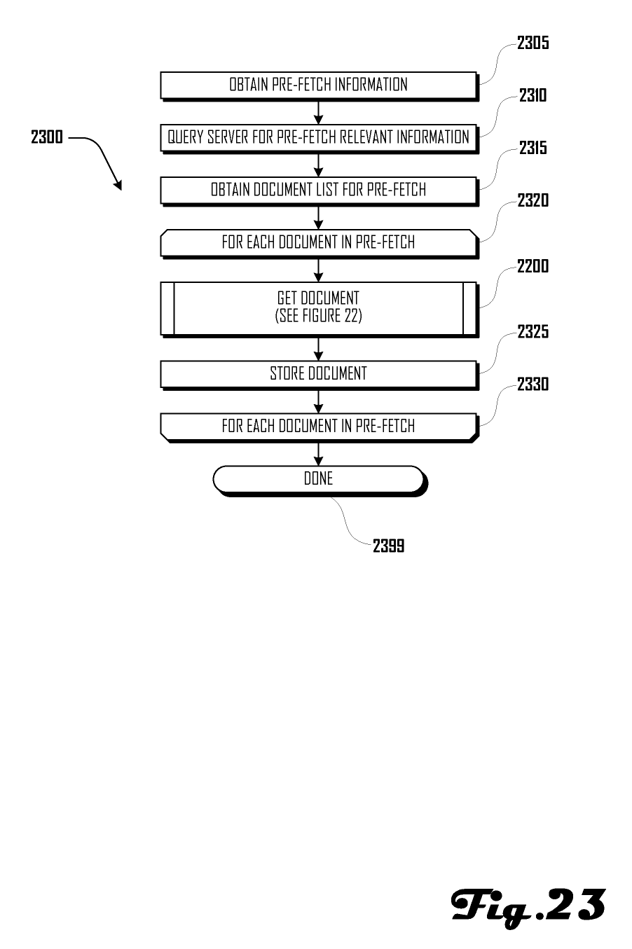

FIG. 23 depicts the process by which an Appliance 300 anticipates the need to retrieve a patient's documents before the actual document retrieval is performed. Appliance 300 may predict the need for such a retrieval under various circumstances, including, but not limited to the following: Patient calls the practice to schedule an appointment for a later date, patient reports at a practice and registers himself/herself. In both these cases and in other ones, the retrieval of the actual clinical documents pertaining to the patient is not performed until some time later, for example, when a physician actually tries to investigate the patient's clinical background. Pre-fetching the clinical information documents from other practices has the benefit of reducing the time the requester of the information has to wait while the documents are fetched from other practices. It also reduces the chances of failure at the time of actual request due to events such as network failures at the time of actual request, since all relevant documents may already be present at the local practice.

When an event at Practice signifies the anticipation of the need to retrieve Patient A's documents from the network predictively (2305), the Appliance A 300A makes a request (2310) to the NSI 200 for a list of all other practices where the same patient's information may be found. The NSI 200 the MPI 298 and finds the relevant records of the patient registration registered practices (e.g., appliances 300). For each document identified (2315), the documents are prefetched using document retrieval subroutine 2200. In prefetch routine 2300, looping block 2320 begins iterating through each document. In subroutine block 2200 (illustrated in FIG. 22 and described above), the document is retrieved. In block 2325 the current document is stored to the document store 399. Next, looping block 2330 cycles back to looping block 2320 until all documents have been iterated through, after which routine 2300 ends at block 2399.

Later, when a user at Appliance 300 requests for documents for Patient-A, the request may be satisfied by simply querying the Document store 399 rather than having to perform a search across the network. In addition to this, the Appliance A 300A may also query the Document Store 299 in the NSI 200 in the event that any peer practices that is known to hold information about Patient-A is inaccessible or unable to return the requested documents.

Note that in addition to the scenarios when a practice requests data generated at another practice, this invention may also be used in cases when a practice needs to be rebuilt after a catastrophic failure. In such a case, the above processes will be followed by a practice that will be requesting for data generated from itself and fetching them from other available sources and using them to rebuild its own document repository.

Although specific embodiments have been illustrated and described herein, it will be appreciated by those of ordinary skill in the art that a variety of alternate and/or equivalent implementations may be substituted for the specific embodiments shown and described without departing from the scope of the present invention. For example, while only two appliances 300A-C have been described, in further embodiments, many more appliances may be used. This application is intended to cover any adaptations or variations of the embodiments discussed herein.

What is claimed is:

1. A computer-implemented method of redundant medical record retrieval, the method comprising:
obtaining patient information;
querying a patient index with said patient information for at least one location of a patient-related document;
querying a first location of said at least one location with said patient information for said patient-related document; and
in response to obtaining said patient related document, storing said patient related document.

2. The method of claim 1, further comprising failing to obtain said patient-related document from said first location; and querying a second location of said at least one location, with said patient information, for said patient-related document.

3. The method of claim 1, wherein said patient index is on a remote server

4. The method of claim 1, further comprising failing to obtain said patient-related document from any of said at least one location; and querying a backup location, with said patient information for said patient-related document.

5. The method of claim 4, wherein said backup location is on remote server

6. A computer implemented method of pre-fetching redundant medical information, method comprising:
obtaining patient information;
querying a patient index, with said patient information, for location information of any documents related to said patient information;
querying at least one location identified in said location information for each of any documents related to said patient information; and
for each of any documents related to said patient information that are obtained, storing said obtained document.
